(19) United States
(12) Patent Application Publication
(10) Pub. No.: US 2011/0008689 A1
(43) Pub. Date: Jan. 13, 2011

(54) SYSTEM AND METHOD FOR HUMIDIFYING A MASTER FUEL CELL STACK WITH A SLAVE FUEL CELL STACK

(75) Inventors: Milos Milacic, New Boston, MI (US); Scott M. Staley, Dearborn, MI (US); William F. Sanderson, Commerce Township, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 12/498,461

(22) Filed: Jul. 7, 2009

(51) Int. Cl. H01M 8/04; H01M 8/18

(52) U.S. Cl. 429/413; 429/428; 429/471

(57) ABSTRACT

A system and method for humidifying a fuel cell stack system is provided. The system includes a slave stack, a master stack and at least one valve. The slave stack generates power to drive a load in response to at least one fluid stream and discharges at least one recirculated fluid stream having water content therein. The master stack receives the at least recirculated fluid stream to humidify the master stack with the water content. The valve delivers the at least one recirculated fluid stream from the slave stack to the master stack based on a power request amount by the load.

### BACKGROUND

1. Technical Field

One or more embodiments of the present invention generally relate to a system and method for humidifying a master fuel cell stack with a slave fuel cell stack.

2. Background Art

It is generally well known that a number of fuel cells are joined together to form a fuel cell stack. Such a stack generally provides electrical current in response to electrochemically converting hydrogen and oxygen into water and energy. The electrical current is used to provide power for various electrical devices in the vehicle or in other suitable mechanisms.

An inherent deficiency of a fuel cell membrane is that the membrane requires humidification to operate properly. Due to such a condition, an additional subsystem is needed to adequately humidify the membrane. During operation of the fuel cell in the automotive environment, the fuel cell operates at lower powers (i.e., current densities), leading to increased humidification demand since not enough product water is being generated. When used as an auxiliary power unit (APU) (i.e., a series hybrid architecture), a small fuel cell stack is used to provide power for charging a battery. Transient regimes are handled by the battery. Such a mode of operation requires fuel cell operation to be scalable in a wide range, thereby requiring careful load and temperature dependent humidification management.

### SUMMARY

In at least one embodiment, a system and method for humidifying a fuel cell stack system is provided. The system includes a slave stack, a master stack and at least one valve. The slave stack generates power to drive a load in response to at least one fluid stream and discharges at least one recirculated fluid stream having water content therein. The master stack receives the at least recirculated fluid stream to humidify the master stack with the water content. The valve delivers the at least one recirculated fluid stream from the slave stack to the master stack based on a power request amount by the load.

### BRIEF DESCRIPTION OF THE DRAWINGS

FIG. 1 illustrates a fuel cell stack system in accordance to one embodiment of the present invention;

FIG. 2 illustrates a method for humidifying a master stack with a slave stack in accordance to one embodiment of the present invention;

FIG. 3 illustrates a fuel cell stack system in accordance to another embodiment of the present invention; and

FIG. 4 illustrates a method for humidifying the master stack with the slave stack in accordance to another embodiment of the present invention.

### DETAILED DESCRIPTION

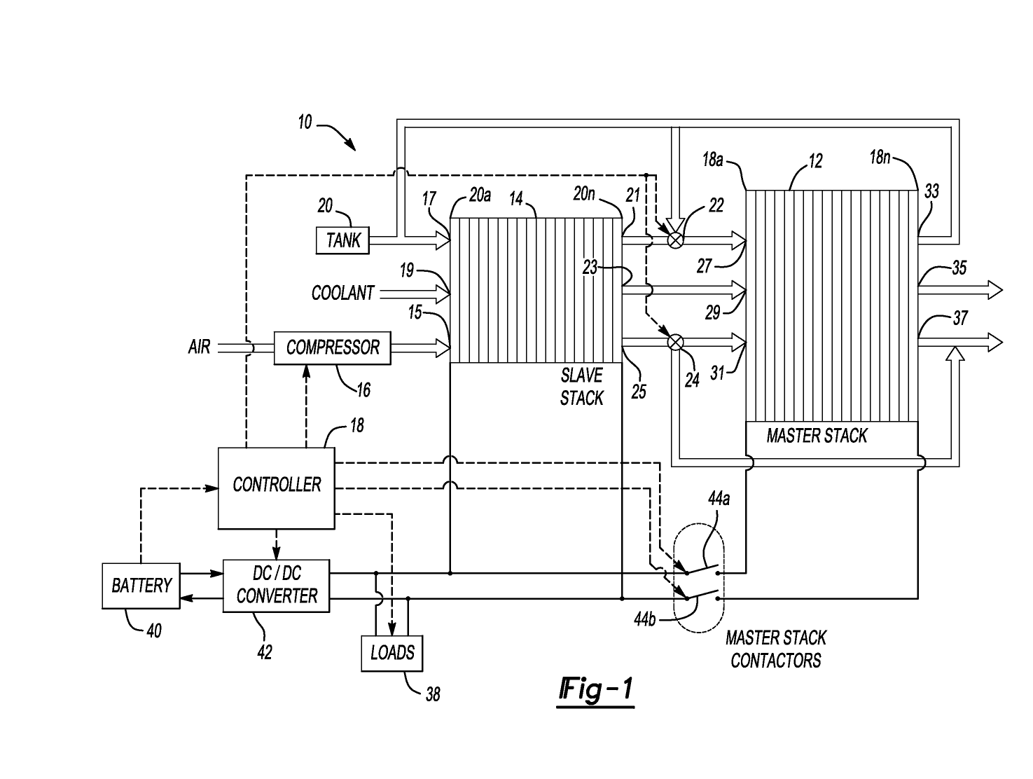

FIG. 1 illustrates a fuel cell stack system 10 in accordance to one embodiment of the present invention. The system 10 is not to be construed as being limited to only vehicle use/function. It is generally contemplated that the system 10 may be used in any such system that is capable of utilizing a fuel cell(s) to generate power for driving a motor, or other electrical loads. The system 10 includes a master fuel cell stack 12 (or master stack 12) and a slave fuel cell stack (or slave stack 14). A first fluid stream (or air stream) which comprises air is fed to an inlet 15 of the slave stack 14. An air compressor 16 receives the first fluid stream prior the inlet 15 of the slave stack 12 to pressurize the air stream. A controller 18 is operatively coupled to the compressor 16 to control the manner in which the compressor 16 pressurizes the air stream.

A tank (or supply) 20 of compressed hydrogen generally provides a second fluid stream (or supply hydrogen) to an inlet 17 of the slave stack 14. The second fluid stream comprises compressed hydrogen that can be used by the slave stack 14. It is generally known that the tank 20 may include a regulator. The regulator may also be positioned external to the tank 20. While compressed hydrogen may be used in the system 10, it is generally understood that any hydrogen fuel source may be implemented in the system 10. For example, liquid hydrogen, hydrogen stored in various chemicals such as sodium borohydride or alanates, or hydrogen stored in metal hydrides may be used instead of compressed gas.

Coolant in the form of de-ionized (DI) water ethylene glycol or other suitable composition is delivered to an inlet 19 of the slave stack 14 for cooling the slave stack 14. The slave stack 14 includes an outlet 21 for discharging recirculated hydrogen, an outlet 23 for discharging coolant, and an outlet 25 for discharging an unused air stream.

First and second bypass valves 22,24 are positioned between the master and the slave stacks 12 and 14 for controlling the flow of recirculated hydrogen and the unused air stream to the master fuel cell stack 12. The master stack 12 includes an inlet 27 for receiving recirculated hydrogen from the outlet 21 of the slave stack 14 and from an outlet 33 of the master stack 12 of the slave stack 14 and/or hydrogen (from the tank 20), and an inlet 29 for receiving coolant (i.e., that is discharged from the slave stack 14). The master stack 12 further includes an inlet 31 for receiving unused air stream from the outlet 25 of the slave stack 14. The master stack 12 includes an inlet 31 for receiving coolant from the slave stack 14. While FIG. 1 illustrates that coolant is delivered from the slave stack 14 to the master stack 12, it is contemplated that the master stack 12 may deliver coolant to the slave stack 14, opposite to that shown in FIG. 1. The master stack 12 includes an outlet 37 for discharging unused air stream.

The controller 18 controls the bypass valve 22 for controlling the manner in which the supply hydrogen, unused hydrogen from the slave fuel cell stack 14, and unused hydrogen from the master fuel cell stack 12 are delivered to the inlet 27 of the master stack 12. The controller 18 controls the bypass valve 24 for controlling the manner in which an unused air stream from the slave stack 14 is delivered to the inlet 31 of the master stack 12.

The master and slave stacks 12,14 are each capable of providing electrical current in response to electrochemically converting hydrogen and oxygen into water and energy. A battery 40 is operatively coupled to the controller 18. It is contemplated that the battery may provide a low voltage (e.g., 12V), a high voltage (e.g., between 250V-350V), or other suitable battery voltage. The particular battery voltage level may vary based on the desired criteria of a given implementation. A DC/DC converter 42 is operatively coupled to the master stack 12, the slave stack 14, the controller 18, and the battery 40.

Loads 38 are operably coupled to the master stack 12, the slave stack 14, the controller 18, and the DC/DC converter 42. Such loads 38 may include, but not limited to, heating/cooling systems, entertainment systems, lighting systems, motors, or other suitable loads generally implemented to receive power from a fuel cell stack. The loads 38 may receive power from the master stack 12 and the slave stack 14. The DC/DC converter 42 may be bi-directional. As such, the DC/DC converter 42 enables the loads 38 to receive power directly from the master stack 12 and/or the slave stack 14 in a first direction. The DC/DC converter 42 may also enable the loads 38 to receive electrical power from the battery 40 (and not from the master and/or the slave stack 12,14). The particular source of power (e.g., the master and slave stacks 12,14 or the battery 40) used to provide power to the loads 38 vary depending on the operating conditions of the battery depending on the operating conditions of the system 10. The controller 18 may disable the master stack 12 and/or the slave stack 14 from transferring power to the loads 38 in the event the battery 40 is required to provide power to the loads 38. To accomplish such a condition, the controller 18 may control the DC/DC converter 42 to prevent current transfer from the slave stack 14 (and/or the master stack 12 if activated) while enabling current transfer from the battery 40 to the loads 38.

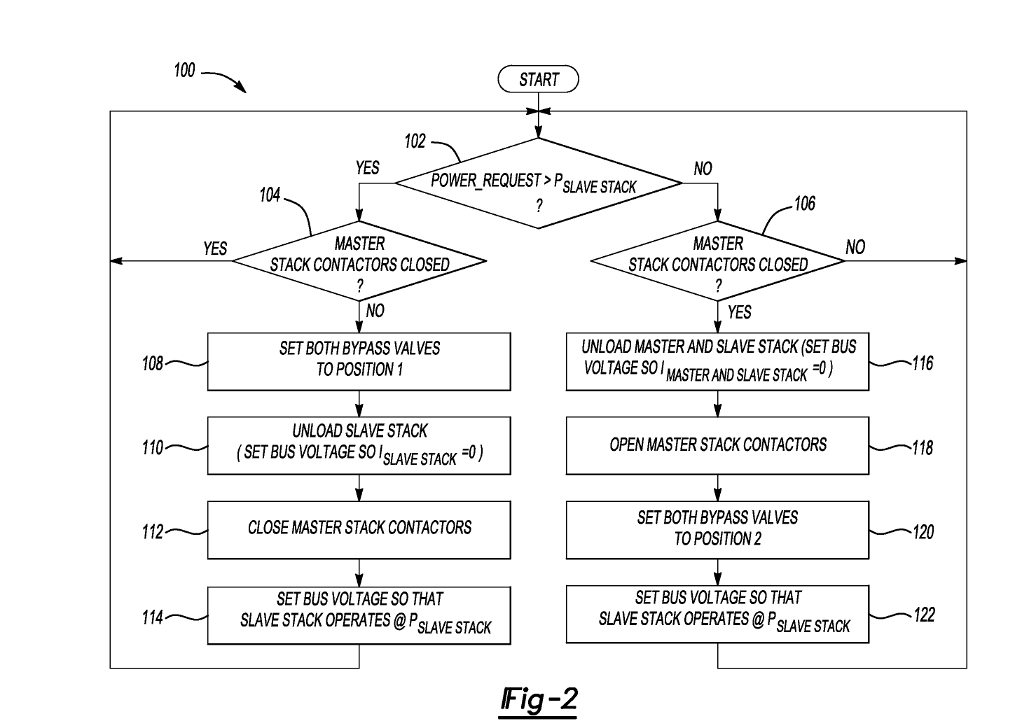

A pair of contactors 44a,44b are coupled to the controller 18. The pair of contactors 44a,44b are controlled by the controller 18 so that the master stack 12 may be selectively activated to be electrically coupled with the slave stack 14, the loads 38, the battery 40, and the DC/DC converter 42. The strategy employed by the controller 18 to selectively activate the master stack 12 will be described in more detail in connection with FIG. 2. It is recognized that the controller 18 may comprise electronics for executing instructions to control one or more features of the system 10. The controller 18 may include an accelerator pedal lookup table for determining the amount of power that is being requested by the driver. Such an implementation takes into account the amount of power requested by the driver to move the vehicle. A power measurement device (not shown) may be coupled to the DC/DC converter 42 (and to the controller 18) to determine the amount of power that is delivered for loads not directly related to the generated amount of torque such as the lighting systems, heating/cooling systems, etc. The controller 18 determines the amount of power that is being requested to move the vehicle by the driver and the amount of power delivered to other such vehicle subsystems/systems. The amount of power being requested generally includes the requested amount to move the vehicle and the amount of power delivered (or consumed) for the vehicle subsystems/systems.

The master stack 12 includes a plurality of fuel cells 18a-18n. The slave stack 14 also includes a plurality of fuel cells 20a-20n. The number of cells implemented within the master stack 12 is similar to the number of cells implemented within the slave stack 14. Such a condition enables the implementation of a single DC/DC converter for receiving electrical power from the master and the slave stacks 12,14. Each cell within the master and the slave stack 12,14 is generally configured to provide, for example, between 0.6 volts to 1.23 volts depending on the power demands of the loads 38 and the operating modes of the system 10. The particular amount of power provided by each fuel cell 18a-18n, 20a-20n within the master and the slave stack 12,14, respectively, may vary based on the desired criteria of a particular implementation. The master stack 12 is generally configured to provide more power than that of the slave stack 14 based on the larger cross section of the fuel cells 18a-18n than the fuel cells 20a-20n of the slave stack 14.

The slave stack 14 is generally the only stack configured to operate in moments in which the requested amount of power to be generated from the loads 38 is below a predetermined power threshold. Such a condition generally occurs in moments in which overall power demand from the loads 38 (e.g., if within a vehicle) is low (e.g., when the vehicle is in an idle mode). The predetermined power threshold is generally defined as the maximum amount of power that the slave stack 14 is capable of generating. In the event power demand from the loads 38 are high (or exceed the predetermined power threshold), the controller 18 closes the contactors 44a,44b to activate the master stack 12 to produce the additional amount of power required by the loads 38. In addition, the controller 18 controls the bypass valves 22,24 to allow air and recirculated hydrogen to be passed from the slave stack 14 to the master stack 12 to humidify membranes within the master stack 12 when both the master and the slave stacks 12,14 are operating. In general, the slave stack 14 is configured to operate at a current density of 0.8 A/cm² or greater. By operating at such a current density, such a condition may ensure that the slave stack 14 generates enough water while generating power so that the water generated by the slave stack 14 is adequate to humidify membranes within the slave stack 14 (e.g., without the use of an external humidifier to humidify the slave stack 14). The slave stack 14 also generates enough water so that membranes in the master stack 12 are adequately hydrated when the master stack 12 is controlled to generate power in the system 10.

By humidifying the master stack 12 in the above described manner, the implementation of a humidifier is generally not needed within the system 10 to humidify the hydrogen and/or air stream that is passed to the master stack 12. Such a condition may provide for a simplified system in which cost may be reduced and reliability may be increased. As shown in FIG. 1, the master stack 12 and the slave stack 14 are fluidly coupled in series with one another. Power demand from the loads 38 may be low during vehicle idle conditions.

FIG. 2 illustrates a method 100 for humidifying the master stack 12 with the slave stack 14 in accordance to one embodiment of the present invention. The controller 18 may include, but not limited to, any number of microprocessors, ASICs, ICs, memory devices (e.g., FLASH, ROM, RAM, EPROM and/or EEPROM), and software which co-act with one another to perform the operations of method 100.

In operation 102, the controller 18 determines the amount of power that is being requested by the driver (e.g. loads that are requested by the driver as the driver steps on the accelerator and/or other vehicle loads requested by the driver) while the slave stack 14 is operating. The controller 18 compares the requested amount of power to the predetermined power threshold. If the requested amount of power is greater than the predetermined power threshold, then the method 100 moves to operation 104. If the requested amount of power is less than the predetermined power threshold, then the method 100 moves to operation 106.

In operation 104, the controller 18 determines whether the contactors 44a-44b are closed. If the contactors 44a-44b are closed, then the method 100 moves back to operation 102. If the contactors 44a-44b are open, then the method 100 moves to operation 108.

In operation 108, the controller 18 controls the bypass valve 22 to open thereby enabling recirculated hydrogen from the slave stack 14 and any such recirculated hydrogen from the outlet 33 of the master stack 12 to flow to the inlet 27 of the master stack 12. Further, the controller 18 controls the bypass valve 24 to open thereby enabling the air stream from the outlet 25 of the slave stack 14 to flow to the inlet 31 of the master stack 12. It is contemplated that first and second humidity sensors (not shown) may be positioned between the bypass valves 22,24 and the inlets 27,31, respectively of the master stack 12. The controller 18 may receive readings from the first and second humidity sensors to determine the amount of water present in the hydrogen and the air stream and adjust the opening of the various valves in the bypass valves 22,24 based on such measured amounts. Examples of humidity sensor implementations that may be utilized within one or more embodiments of the present invention is disclosed in U.S. Ser. No. 11/163,166 filed on Oct. 7, 2005 and in U.S. Ser. No. 11/355,566 filed on Feb. 15, 2006.

In operation 110, the controller 18 controls the DC/DC converter 42 and the loads 38 to receive the amount of power that is being produced by the slave stack 14. The controller 18 controls the DC/DC converter 42 to enable power transfer from the battery 40 to the loads 38 as opposed to enabling power transfer from the slave stack 14 to the loads 38. In general, the amount of current being delivered from the slave stack 14 at this moment is zero. Such a condition may be needed so that the voltage between the master stack 12 and the slave stack 14 are equalized during the transition to prevent arcing from occurring once the contactors 44a,44b are closed. If the slave stack 14 was to continue generating power to feed the loads 38 while activating the master stack 12 (by closing the contacts 44a,44b), arcing may occur across the contactors 44a,44b and weld the contacts of the contactors 44a,44b in a permanent closed state.

In operation 112, the controller 18 closes the contactors 44a,44b to activate the master stack 12.

In operation 114, the controller 18 controls the DC/DC converter 42 to deliver power to the battery 40 thereby enabling the slave stack 14 to generate and deliver power to the loads 38. Likewise, the master stack 12 generates the additional amount of power required by the loads 38. In this case, the slave stack 14 is operating and thereby discharging fluids (e.g., recirculated hydrogen, coolant, and air stream) to the master stack 12. As noted above, the recirculated hydrogen and air stream includes water content that may be sufficient to humidify the membranes of the master stack 12. Each of the recirculated hydrogen and air stream discharged from the slave stack 14 may be hot and include a relative humidity of approximately 100%. Such a condition may ensure that the hydrogen and air stream that is discharged by the slave stack 14 may include adequate water content. The battery 40 may receive and store power generated from the master stack 12 and the slave stack 14 in this operation.

Operations 106, 116, 118, 120, and 122 are executed in response to the controller 18 determining that the amount of power requested by the driver is below the predetermined power threshold.

In operation 106, the controller 18 determines whether the contactors 44a-44b are closed. If the contactors 44a-44b are open, then the method 100 moves back to operation 102. If the contactors 44a-44b are closed, then the method 100 moves to operation 116.

In operation 116, the controller 18 controls the battery 40 to provide the amount of power that is being produced by the master stack 12 and the slave stack 14. The controller 18 controls the DC/DC converter 42 to enable power transfer from the battery 40 to the loads 38 as opposed to enabling power transfer from the master stack 12 and the slave stack 14 to the loads 38. In general, the amount of current being delivered from the master stack 12 and the slave stack 14 at this moment is zero. Such a condition may be needed so that the voltage between the master stack 12 and the slave stack 14 are equalized as noted above in connection with operation 110.

In operation 118, the controller 18 opens the contactors 44a,44b to deactivate the master stack 12 (e.g., disable the master stack 12 from generating current (or power)) in response to the determining that the current being discharged from the master stack 12 and the slave stack 14 is zero.

In operation 120, the controller 18 controls the bypass valve 22 to close thereby preventing the recirculated hydrogen from the outlet 21 of the slave stack 14 and any such recirculated hydrogen from the outlet 33 of the master stack 12 from flowing into the inlet 27 of the master stack 12. Further, the controller 18 controls the bypass valve 24 to close thereby preventing the air stream from the outlet 25 of the slave stack 14 to flow into the inlet 31 of the master stack 12.

In operation 122, the controller 18 controls the DC/DC converter 42 to deliver power to the battery 40 and to the loads 38. The battery 40 may receive and store power generated from the slave stack 14 (via the DC/DC converter 42) in this operation.

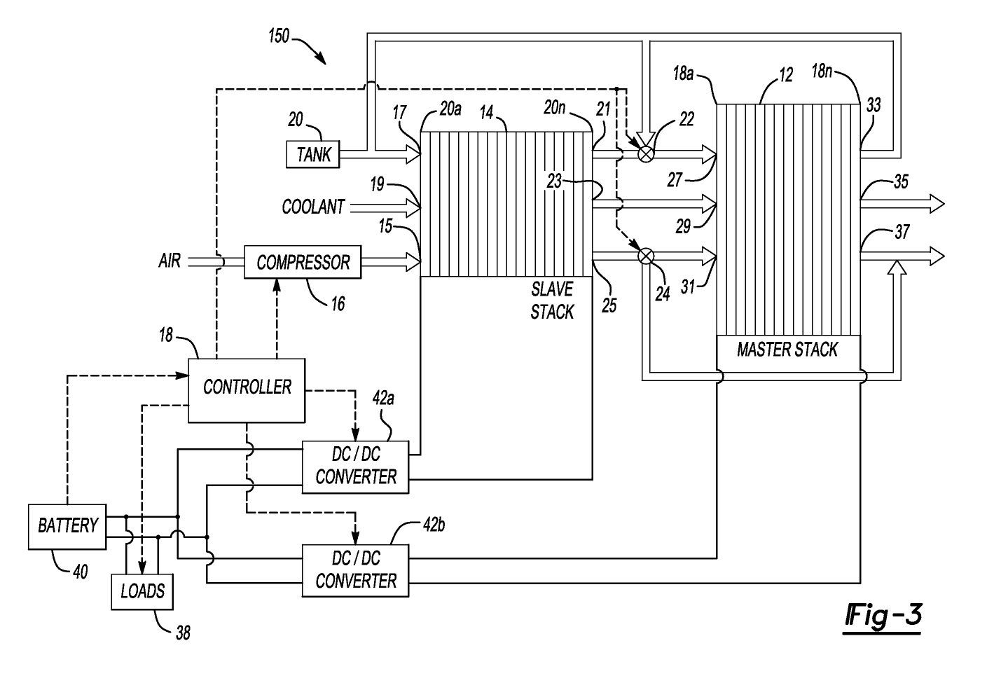

FIG. 3 illustrates a fuel cell stack system 150 in accordance to one embodiment of the present invention. The system 150 is not to be construed as being limited to only vehicle use/function. It is generally contemplated that the system 150 may be used in any such system that is capable of utilizing a fuel cell(s) to generate power for driving a motor or other electrical load. The system 150 differs from the system 10 in that at least two DC/DC converters 42a,42b are implemented for the system 150. Such a condition may be necessary because the number of fuel cells 18a-18a within the master stack 12 are different from the number of fuel cells 20a-20n in the slave stack 14. In view of the aforementioned condition, the bus voltages for the master stack 12 and the slave stack 14 are different from one another because the master stack 12 and the slave stack 14 have different power generating capabilities based on the number of fuel cells positioned therein.

Each of the DC/DC converters 42a,42b are uni-directional. The DC/DC converters 42a,42b enable power transfer from the slave stack 14 and the master stack 12, respectively to the loads 38 and the battery 40. The controller 18 selectively activates/deactivates the master and slave stack 12,14 by controlling the DC/DC converters 42a,42b respectively. The DC/DC converters 42a,42b may function in place of the contactors 44a,44b as noted in connection with FIG. 1 to activate/deactivate the master and slave stacks 12,14. For example, in moments in which the loads 38 operate in a low power mode operations (e.g., requested power from the loads 38 are below the predetermined power threshold), the controller 18 may control the DC/DC converter 42a to enable power transfer from the slave stack 14 to the loads 38 and/or battery 40. In the event the requested power from the loads 38 is greater than the predetermined power threshold, then the controller 18 may control the DC/DC converter 42b to enable power transfer from the master stack 12 to the loads 38 and/or the battery 40.

In addition, the controller 18 controls the bypass valves 22,24 to allow hydrogen and air to be passed from the slave stack 14 to the master stack 12 to humidify membranes within the master stack 12 when both the master and the slave stacks 12,14 are operating. It is recognized that the hydrogen and air from the slave stack 12 may include enough water content to humidify the membranes of the master stack 12. By humidifying the master stack 12 in the above described manner, the implementation of a humidifier is not needed within the system 150. As shown in FIG. 3, the master stack 12 and the slave stack 14 are fluidly coupled in series with one another.

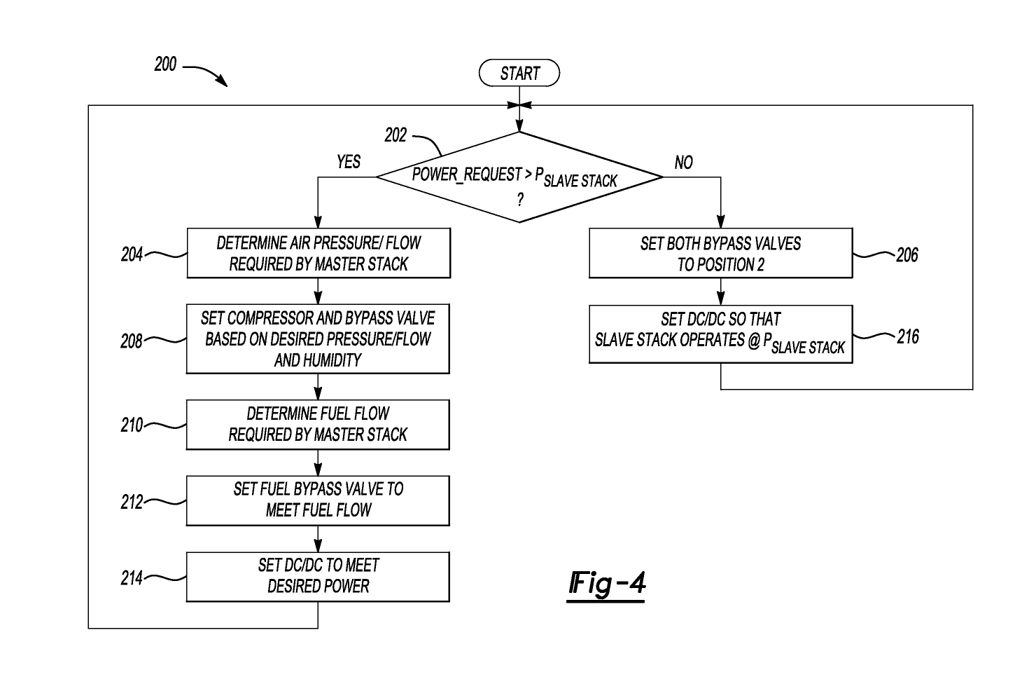

FIG. 4 illustrates a method 200 for humidifying the master stack 12 with the slave stack 14 in accordance to one embodiment of the present invention. The controller 18 may include, but not limited to, a number of microprocessors, ASICs, ICs, memory devices (e.g., FLASH, ROM, RAM, EPROM and/or EEPROM), and software which co-act with one another to perform the operations of method 200.

In operation 202, the controller 18 determines the amount of power that is being requested by the driver (e.g., loads that are requested by the driver as the driver steps on the accelerator and/or other vehicle loads requested by the driver) while the slave stack 14 is operating. The controller 18 compares the requested amount of power to the predetermined power threshold. If the requested amount of power is greater than the predetermined power threshold, then the method 200 moves to operation 204. If the requested amount of power is less than the predetermined power threshold, then the method 200 moves to operation 206.

In operation 204, the controller 18 determines the amount of air pressure or air flow needed by the master stack 12 based on the amount of power that is being requested by the driver.

In operation 208, the controller 18 controls the compressor 18 to adjust the pressure flow of the air stream to the slave stack 14 and controls the bypass valve 24 in accordance to the air flow indicated in operation 204 to open so that the air stream that is delivered to the inlet 31 of the master stack 12 is sufficient to meet humidification requirements of the master stack 12. As noted above in connection with FIG. 2, a humidity sensor (not shown) may be positioned between the bypass valve 24 and the inlet 31 of the master stack 12 to provide signals to the controller 18 so that the amount of moisture in the air stream can be determined.

In operation 210, the controller 18 determines the amount of hydrogen that is needed to be delivered to the master stack 12. The controller 18 determines the amount of hydrogen that is needed by monitoring the amount of power that is being requested by the driver. A bypass valve (not shown) may be positioned between the tank 20 for controlling the flow of hydrogen into the slave stack 14 in response to signals from the controller 18.

In operation 212, the controller 18 controls the bypass valve 22 to open so that the hydrogen that is delivered to the inlet 27 of the master stack 12 is sufficient to meet humidification requirements of the master stack 12 (e.g., the hydrogen includes adequate moisture to hydrate the membranes of the master stack 12). As noted above in connection with FIG. 2, a humidity sensor (not shown) may be positioned between the bypass valve 22 and the inlet 27 of the master stack 12 to provide signals to the controller 18 so that the amount of moisture in the hydrogen can be determined.

In operation 214 the controller 18 controls the DC/DC converter 42a and 42b to enable power transfer from the master stack 12 and the slave stack 14 to the loads 38 and the battery 40 to provide the requested amount of power needed by the driver.

Operations 204, 208, 210, 212, and 214 are executed in response to the controller 18 determining that the amount of power requested by the driver is greater than the predetermined power threshold. Operations 206 and 216 are executed in response to the controller 18 determining that the amount of power being requested by the loads 38 are less than the predetermined power threshold.

In operation 206, the controller 18 controls the bypass valves 22,24 to close thereby preventing the flow of the air stream and the hydrogen to the master stack 12. It is not necessary to activate the master stack 12 to generate power since the power demand from the loads 38 can be sustained from the slave stack 14.

In operation 216, the controller 18 controls the DC/DC converter 42a to remain on to allow power transfer from the slave stack 14 to the loads 38 and/or the battery 40.

While embodiments of the present invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A system for humidifying a fuel cell stack system comprising:
a slave stack for generating power to drive a load in response to at least one fluid stream and to discharge at least one recirculated fluid stream having water content therein;
a master stack for receiving the at least recirculated fluid stream to humidify the master stack with the water content; and
at least one valve for delivering the at least one recirculated fluid stream from the slave stack to the master stack based on a power request amount by the load.

2. The system of claim 1 further comprising a controller operatively coupled to the at least one valve, the controller being configured to control an amount of water content that is delivered to the master stack with the at least one valve.

3. The system of claim 2 wherein the controller is further configured to determine the power request amount by the load prior to controlling the amount of water content that is to be delivered to the master stack with the at least one valve.

4. The system of claim 3 wherein the controller is further configured to compare the power request amount to a predetermined power threshold.

5. The system of claim 4 wherein the controller is further configured to control the at least one valve to deliver the at least one recirculated fluid stream from the slave stack to the master stack in response to determining that the power request amount is greater than the predetermined power threshold.

6. The system of claim 1 wherein the master stack includes a plurality of master fuel cells and the slave stack includes a plurality of slave fuel cells and the number of master fuel cells is equal to the number of slave fuel cells.

7. The system of claim 1 wherein the master stack includes a plurality of master fuel cells and the slave stack includes a plurality of slave fuel cells and the number of master fuel cells is different from the number of slave fuel cells.

8. The system of claim 1 wherein the slave stack is configured to operate at a current density of 0.8 A/cm².

9. A method for humidifying a fuel cell stack system in a vehicle, the method comprising:
generating power, with a slave stack, to drive a load in response to at least one fluid stream;
discharging at least one recirculated fluid stream having water content therein from the slave stack;
receiving the at least recirculated fluid stream, at a master stack, to humidify the master stack with the water content; and
delivering the at least one recirculated fluid stream, with at least one valve, from the slave stack to the master stack based on a power request amount by the load.

10. The method of claim 9 further comprising determining the power request amount by the load prior to delivering the at least one recirculated fluid stream.

11. The method of claim 10 further comprising comparing the power request amount to a predetermined power threshold.

12. The method of claim 11 further comprising controlling the at least one valve to deliver the at least one recirculated fluid stream from the slave stack to the master stack in response to determining that the power request amount is greater than the predetermined power threshold.

13. The method of claim 9 further comprising operating the slave stack at a current density of 0.8 A/cm² or greater so that the master stack and the slave stack are humidified with the water content without the need for an external humidification system to humidify the at least one fluid stream and the at least one recirculated fluid stream.

14. The method of claim 9 further comprising providing a plurality of master fuel cells in the master stack and providing a plurality of slave fuel cells in the slave stack, wherein the number of master fuel cells is equal to the number of slave fuel cells.

15. The method of claim 9 further comprising providing a plurality of master fuel cells in the master stack and providing a plurality of slave fuel cells in the slave stack, wherein the number of master fuel cells is different than the number of slave fuel cells.

16. A device for controlling humidification of a master stack with a slave stack in a vehicle comprising:
a controller configured to control a valve to deliver at least one recirculated fluid stream having water content therein that is discharged from the slave stack to the master stack to hydrate membranes within the master stack with the water content based on a power request amount by a load.

17. The device of claim 16 wherein the controller is further configured to determine the power request amount for the load and to compare the power request amount to a predetermined power threshold.

18. The device of claim 17 wherein the controller is further configured to control the valve to deliver the at least one recirculated fluid stream from the slave stack to the master stack in response to determining that the power request amount is greater than the predetermined power threshold.
